(19) United States
(12) Patent Application Publication
(10) Pub. No.: US 2022/0355753 A1
(43) Pub. Date: Nov. 10, 2022

(54) VEHICULAR COMPONENT HAVING SHOCK ABSORBING STRUCTURE

(71) Applicant: UACJ Corporation, Tokyo (JP)

(72) Inventors: Kittipan PONGMORAKOT, Tokyo (JP); Tatsuo INAGAKI, Tokyo (JP)

(21) Appl. No.: 17/621,577

(22) PCT Filed: Sep. 7, 2020
(86) PCT No.: PCT/JP2020/033720

§ 371 Date: Dec. 21, 2021

(30) Foreign Application Priority Data
Sep. 6, 2019 (JP) 2019-162719

(51) Int. Cl. B60R 19/18; B60R 19/24; B60R 19/04

(52) U.S. Cl. CPC B60R 19/18; B60R 19/24; B60R 19/04; B60R 2019/182

(57) ABSTRACT

A shock absorbing component (a vehicular component having a shock absorbing structure) formed from an aluminum alloy hollow extrusion in an elongated shape includes a collision wall, a non-collision wall, an upper wall, a lower wall, and an inner rib. The collision wall forms a collision surface. The non-collision wall forms a non-collision surface 1B. The upper wall and the lower wall 40 connect the collision wall to the non-collision wall. The shock absorbing component is mounted to a vehicle with a stay (a mounting member) on the non-collision surface. The collision wall and the non-collision wall include joint portions joined to the inner rib. The joint portions of the collision wall and the non-collision wall include a collision wall-side recess formed by recessing the collision wall toward the inner rib in the longitudinal direction of the shock absorbing component and a non-collision wall-side recess formed by recessing the non-collision wall toward the inner rib in the longitudinal direction.

### TECHNICAL FIELD

The present disclosure relates to a vehicular component having a shock absorbing structure and particularly relates to a shock absorbing structure that can absorb energy with a favorable degree of efficiency in an offset-collision.

### BACKGROUND ART

Front portions and rear portions of vehicles such as automobiles may be equipped with vehicular components having shock absorbing structures for absorbing impacts in collisions. The vehicular components having the shock absorbing structures may be mounted horizontally to the vehicles to extend in a width direction of the vehicles. The vehicular components having the shock absorbing structures may be broadly classified into two types, the vehicular components having the shock absorbing structures in linear shapes (a linear type) and the vehicular components having the shock absorbing structures in curved shapes (a curved type). The vehicular components having the shock absorbing structures in the linear shapes include middle portions and end portions that extend parallel to the width direction of the vehicles. The vehicular components having the shock absorbing structures in the curved shapes may include linear middle portions and bent or curved portions at ends of the middle portions. The bent portions are bent toward vehicle bodies. The curved portions are curved toward the vehicle bodies. Alternatively, the vehicular components having the shock absorbing structures in the curved shapes may be curved toward the vehicle bodies throughout lengths.

The vehicular components having the shock absorbing structures should be efficient in energy absorption in head-on collisions (flat barrier collisions, full-wrap collisions). Hollow extrusions may be used for vehicular components having shock absorbing structures to reduce wights. Configurations of such vehicular components including inner ribs are proposed. For example, Patent Document 1 and Patent Document 2 disclose vehicular components having shock absorbing structures (bumper reinforcement members) in which energy absorption efficiency is increased. The vehicular components include recesses in joint portions of the collision walls (front walls) joined to inner ribs (intermediate walls) to increase buckling strength of the inner ribs.

### RELATED ART DOCUMENT

[Patent Document]

[Patent Document 1]

Japanese Patent Publication No. 4035292

[Patent Document 2]

Japanese Patent Publication No. 5203870

### SUMMARY OF THE INVENTION

### Problem to be Solved by the Invention

In recent years, it is expected that a vehicular component having a shock absorbing structure absorbs energy with a high degree of efficiency in an offset-collision in which a portion of a vehicle collides with another vehicle or an obstacle. If the vehicular component having the shock absorbing structure is mounted to the vehicle with a mounting member, an influence of a collision load during the offset-collision may vary according to a positional relation between a point at which the mounting member is mounted (hereinafter may be referred to as a mounting point) and a point to which the collision load is applied (hereinafter may be referred to as a load point).

Through research of the inventors of the present application, it is confirmed that the vehicular component having the shock absorbing structure in Patent Document 1 or Patent Document 2 is less likely to achieve a proper degree of energy absorption efficiency in a collision in which the load point is outer than the mounting point in the width direction of the vehicle although a certain degree of improvement in energy absorption efficiency is observed in a collision in which the load point is inner than the mounting point. If the collision load is applied to a point outer than the mounting point in the width direction of the vehicle, a stress against the collision load tends to concentrate on the mounting point at which the inner ribs are mounted. Therefore, the inner ribs may buckle near the mounting point and the vehicular component having the shock absorbing structure may largely deform in a relatively early stage of the collision. When the inner ribs buckle, the load-bearing capacity sharply decreases. Therefore, when the inner ribs buckle in the early stage of the collision, the energy may not be sufficiently absorbed in the offset-collision.

The technology described herein was made in view of the above circumstances. An object is to provide a vehicular component having a shock absorbing structure that can absorb energy with a favorable degree of efficiency in an offset-collision, especially in a collision in which a load point is outer than a mounting point in a width direction of a vehicle.

### Means for Solving the Problem

Through intensive studies on the above problem, the inventors of the present application found that the energy absorbing efficiency was effectively increased and thus the high collision performance was delivered especially in an offset collision in which a collision load was applied to a point outer than the mounting point in the width direction of the vehicle by forming the recess in the non-collision wall of the vehicular component having the shock absorbing structure to extend in the longitudinal direction.

A vehicular component having a shock absorbing structure according to the technology described herein has the following configuration.

(1) The vehicular component having the shock absorbing structure is formed from an aluminum alloy hollow extrusion in an elongated shape and mounted to a vehicle to absorb an impact in a collision. The vehicular component having the shock absorbing structure includes a collision wall, a non-collision wall, an upper wall, a lower wall, and an inner rib. The collision wall is disposed in a vertical direction. The collision wall includes a plate surface that is defined as a collision surface. The non-collision wall is disposed parallel to the collision wall on an opposite side from the collision surface. The non-collision wall includes a plate surface that is disposed on an opposite side from the collision wall and defined as a non-collision surface. The upper wall and the lower wall connect the collision wall to the non-collision wall. The inner rib is disposed between the upper wall and the lower wall to connect the collision wall to the non-collision wall. The vehicular component having the shock absorbing structure is mounted to the vehicle with a mounting member on the non-collision surface. The collision wall includes a joint portion joined to the inner rib. The non-collision wall includes a joint portion joined to the inner rib. The joint portion of the collision wall includes a recess formed by recessing the collision wall toward the inner rib in a longitudinal direction of the vehicular component having the shock absorbing structure. The joint portion of the non-collision wall includes a recess formed by recessing the non-collision wall toward the inner rib in the longitudinal direction of the vehicular component having the shock absorbing structure.

The vehicular component having the shock absorbing structure according to the technology described herein may have the following configuration.

(2) In (1), the recess in the non-collision wall extends at least from a mounting point at which the mounting member is mounted to a free and at an end of the vehicular component having the shock absorbing strutter in the longitudinal direction.

The vehicular component having the shock absorbing structure according to the technology described herein may have the following configuration.

(3) In (1) or (2), when a distance between the collision surface and the non-collision surface is defined as T, a length of the inner rib in a direction in which the collision wall and the non-collision wall are connected is in a range from 0.5T to 0.83T including 0.83T.

The vehicular component having the shock absorbing structure according to the technology described herein may have the following configuration.

(4) In any one of (1) to (3), when a length of the non-collision surface in a top-bottom direction is defined as W, a shift amount of the inner rib from a middle of the vehicular component having the shock absorbing structure in the top-bottom direction is equal to or less than 0.14 W.

The vehicular component having the shock absorbing structure according to the technology described herein may have the following configuration.

(5) In any one of (1) to (4), the recess in the non-collision wall has a cross section perpendicular to the longitudinal direction in a bow shape, an oval bow shape, a rectangular shape, or a triangular shape.

The vehicular component having the shock absorbing structure according to the technology described herein may have the following configuration.

(6) In any one of (1) to (5), when an opening width of the recess in the non-collision surface of the non-collision wall is defined as 2H and a depth from the non-collision surface is defined as F, a ratio F/H is in a range from 0.3 to 1.6 including 1.6.

### Advantageous Effects of Invention

According to the technology, a vehicular component having a shock absorbing structure that absorbs energy with a high degree of efficiency especially in an offset collision can be provided.

### BRIEF DESCRIPTION OF THE DRAWINGS

FIG. 1 is a schematic perspective view of a shock absorbing component (a vehicular component having a shock absorbing structure) according to an embodiment.

FIG. 2 is an example of a cross section of the shock absorbing component.

FIG. 3 is a plan view of a shock absorbing component model.

FIG. 4 is a view illustrating profiles of shock absorbing component models according to examples and comparative examples used in evaluation experiments 1 to 6 and evaluation results.

FIG. 5A is a cross-sectional view of the shock absorbing component model according to example 1 used in evaluation experiment 1.

FIG. 5B is a cross-sectional view of the shock absorbing component model according to comparative example 1 used in evaluation experiment 1.

FIG. 5C is a cross-sectional view of the shock absorbing component model according to comparative example 2 used in evaluation experiment 1.

FIG. 6 is a load-stroke diagram measured in evaluation experiment 1.

FIG. 7 is a load-stroke diagram measured in evaluation experiment 2.

FIG. 8 is a load-stroke diagram measured in evaluation experiment 3.

FIG. 9A is a cross-sectional view of the shock absorbing component model according to example 1 used in evaluation experiment 4.

FIG. 9B is a cross-sectional view of the shock absorbing component model according to example 10 used in evaluation experiment 4.

FIG. 9C is a cross-sectional view of the shock absorbing component model according to example 11 used in evaluation experiment 4.

FIG. 9D is a cross-sectional view of the shock absorbing component model according to example 12 used in evaluation experiment 4.

FIG. 10 is a load-stroke diagram measured in evaluation experiment 4.

FIG. 11 is a load-stroke diagram measured in evaluation experiment 5.

FIG. 12 is a load-stroke diagram measured in evaluation experiment 6.

### MODES FOR CARRYING OUT THE INVENTION

### Embodiment

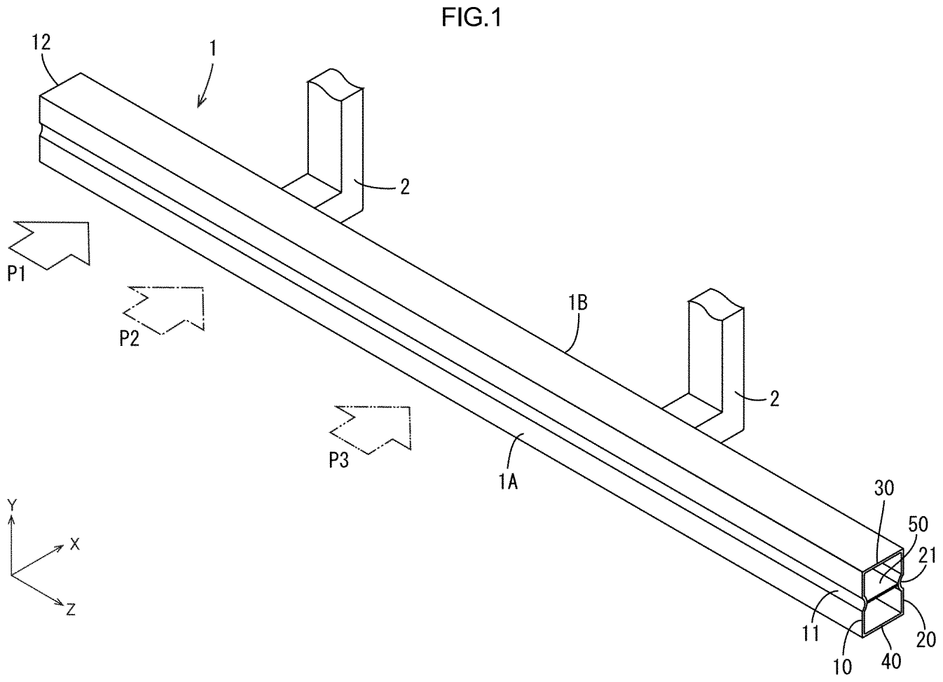

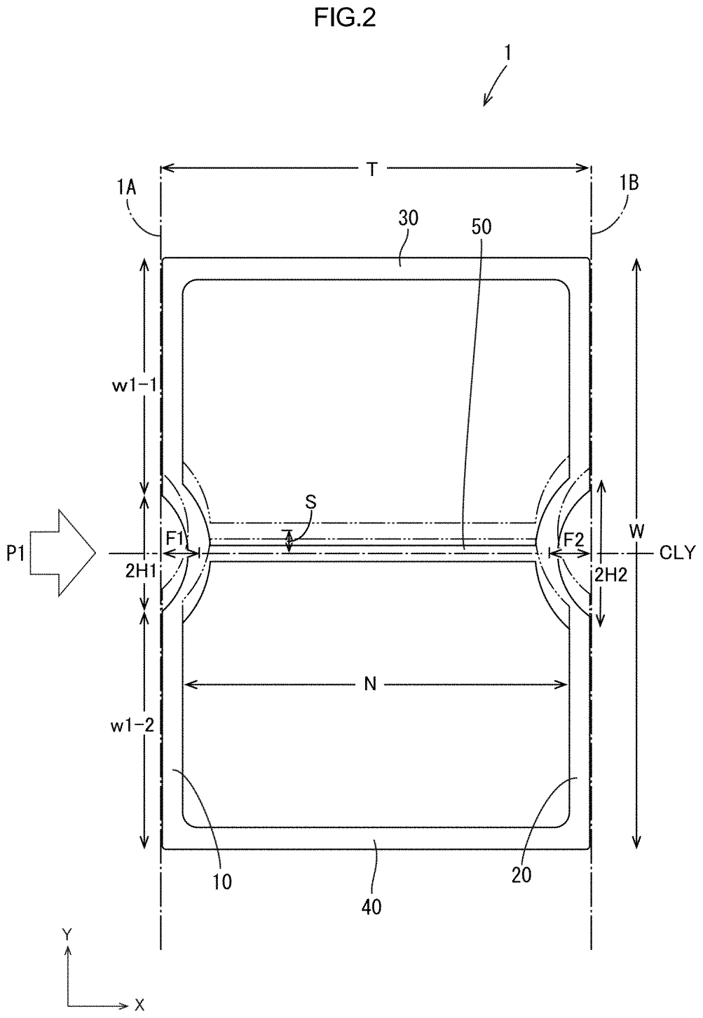

A first embodiment will be described with reference to FIGS. 1 and 2. A truck may include a rear under-run protection (RUP) device, which is a shock absorbing system, on a rear wall to restrict a passenger vehicle from underrun when the passenger vehicle crashes into the back surface of the truck. A shock absorbing component 1 (an example of a vehicular component having a shock absorbing structure) included in this embodiment for an RUP will be described. An upper side (a lower side) in FIG. 1 corresponds to an upper side (a lower side). A lower left (an upper right) of the sheet of FIG. 1 corresponds to a rear side (a front side). An upper left (a lower right) of the sheet of FIG. 1 corresponds to a left side (a right side). X-axes, Y-axes, and Z-axes may be present in some drawings. The axes in each drawing indicate directions that correspond to directions indicated by the respective axes in other drawings. Regarding components having the same configuration, some of the components may be indicated by reference signs and others may not be indicated by the reference signs.

FIG. 1 is a perspective view schematically illustrating the shock absorbing component 1 according to this embodiment. As illustrated in FIG. 1, the shock absorbing component 1 has an elongated shape. The shock absorbing component 1 includes a middle portion and end portions and linearly extends parallel to a width direction of a vehicle as a whole. The shock absorbing component 1 is classified as a liner-type vehicular component having a shock absorbing structure. The shock absorbing component 1 is mounted to the vehicle with a longitudinal direction of the shock absorbing component 1 matching the width direction, that is, a right-left direction of the vehicle. In each drawing, the Z-axis direction, the Y-axis direction, and the X-axis direction correspond to the width direction of the vehicle, a top-bottom direction, a front-rear direction, respectively.

The shock absorbing component 1 is formed from an aluminum alloy hollow extrusion. Conventional vehicular components having shock absorbing structures are made of steel. The shock absorbing component 1 made of aluminum alloy is reduced in weight. To achieve a sufficient strength while achieving benefits of the reduced weight, an aluminum alloy having a higher strength is preferable for the aluminum alloy used for extrusion of the shock absorbing component 1. Examples of the aluminum alloy include, but not limited to, 6000 series (Al—Mg—Si series) aluminum alloy and 7000 series (Al—Zn—Mg series) aluminum alloy in terms of the strength and corrosion resistance. Especially, the 7000 series aluminum alloy that has a higher strength may be preferable.

FIG. 2 illustrates an example of an X-Y cross section (a cross section perpendicular to the longitudinal direction) of the shock absorbing component 1 according to this embodiment. The shock absorbing component 1 includes the hollow extrusion having a B-shaped cross section. Specifically, as illustrated in FIG. 1, the shock absorbing component 1 includes a collision wall 10, a non-collision wall 20, an upper wall 30, and a lower wall 40. The collision wall 10 and the non-collision wall 20 are disposed in the vertical position and parallel to the Y-Z plane. The upper wall 30 and the lower wall 40 are disposed in the horizontal position and parallel to the X-Z plane. An inner rib 50 is disposed between the upper wall 30 and the lower wall 40. The inner rib 50 is disposed in the horizontal position and parallel to the X-Z plane to connect the collision wall 10 to the non-collision wall 20. The walls may be substantially parallel to the vertical direction or the horizontal direction, that is, may be slanted or curved as long as the walls fulfill the functions.

The collision wall 10 receives a collision load. One of plate surfaces of the collision wall 10 is defined as a collision surface 1A. The rear surface of the shock absorbing component 1 that absorbs an impact of the rear-end collision by a vehicle on the back according to this embodiment is defined as the collision surface 1A. The non-collision wall 20 is disposed on an opposite side from the collision surface 1A of the collision wall 10 and parallel to the collision surface 1A. A plate surface of the non-collision wall 20 on an opposite side from the collision wall 10 is a front surface of the shock absorbing component 1 and defined as a non-collision surface 1B. Upper edges of the collision wall 10 and the non-collision wall 20 are connected to each other with the upper wall 30. Lower edges of the collision wall 10 and the non-collision wall 20 are connected to each other with the lower wall 40. The collision wall 10, the non-collision wall 20, the upper wall 30, and the lower wall 40 define a hollow inside the shock absorbing component 1.

The inner rib 50 is disposed between the upper wall 30 and the lower wall 40 to divide the hollow into two. When the collision load is applied to the collision surface 1A toward the non-collision wall 20 (toward the front side), the inner rib 50 supports the collision wall 10 together with the upper wall 30 and the lower wall 40 so that the shape of the hollow inside the shock absorbing component 1 is less likely to be deformed and thus the rigidity of the shock absorbing component 1 is maintained. Namely, the shock absorbing component 1 has a function to develop a large initial load. Influences of a length and a position of the inner rib 50 on collision performance will be evaluated later.

The upper wall 30, the lower wall 40, and the inner rib 50 that are disposed such that normal directions relative to the plate surfaces are perpendicular to a load direction to support the collision wall 10 may be formed to be gradually reduced in thickness (wall thickness) from a non-collision wall 20 side to a collision wall 10 side. According to the configuration, the load from the collision wall 10 is spread and transmitted to the non-collision wall 20. Therefore, the rigidity is less likely to be reduced due to the reduction in thickness. In comparison to a configuration in which the upper wall 30, the lower wall 40, and the inner rib 50 have constant thicknesses, the weight can be reduced without a significant reduction in initial load. Only one or some of the upper wall 30, the lower wall 40, and the inner rib 50 may have such configurations. In this embodiment, the upper wall 30 and the lower wall 40 of the shock absorbing component 1 have wall thicknesses that are gradually reduced from the non-collision wall 20 side to the collision wall 10 side.

As illustrated in FIG. 2, a joint portion of the collision wall 10 joined to the inner rib 50 includes a collision wall-side recess 11. The collision wall-side recess 11 of the collision wall 10 is recessed toward the inner rib in the longitudinal direction of the shock absorbing component 1. Namely, the collision wall-side recess 11 opens toward the collision surface 1A (toward the rear side). With the collision wall-side recess 11, the length of the inner rib 50 is reduced to suppress buckling of the inner rib 50. Wall portions of the collision wall 10 on the collision surface 1A have wall widths w1-1 and w1-2, respectively (see FIG. 2). The wall widths w1-1 and w1-2 decrease and thus a width-to-thickness ratio of the collision wall 10 having the constant thickness increases and thus the buckling strength of the collision wall 10 may increase (Patent Document 1). In FIG. 2 or other drawings, the collision wall-side recess 11 having a bow-shaped cross section is present as an example. However, the shape of the collision wall-side recess 11 is not limited. Influences of the shape and dimensions of the collision wall-side recess 11 on the collision performance will be evaluated later.

A joint portion of the non-collision wall 20 of the shock absorbing component 1 according to this embodiment joined to the inner rib 50 includes a non-collision wall-side recess 21. The non-collision wall-side recess 21 is recessed toward the inner rib 50 in the longitudinal direction of the shock absorbing component 1. Namely, the non-collision wall-side recess 21 opens toward the non-collision surface 1B (toward the front side). In FIG. 2 or other drawings, the non-collision wall-side recess 21 having a bow-shaped cross section, similar to the collision wall-side recess 11, is present as an example. However, the shape of the non-collision wall-side recess 21 is not limited. Influences of the shape and dimensions of the non-collision wall-side recess 21 on the offset-collision performance will be evaluated later.

The shock absorbing component 1 formed from the aluminum alloy hollow extrusion is mounted to a vehicle body, which is not illustrated, with stays 2 (an example of a mounting member) on the non-collision surface 1B illustrated in FIG. 1 and supported. Normally, two stays 2 are separated from each other in the longitudinal direction of the shock absorbing component 1. Ends of the shock absorbing component 1 with respect to the width direction of the vehicle are configured as free ends 12. A method of coupling the stays 2 to the shock absorbing component 1 is not limited to a specific method. The stays 2 may be fixed to the shock absorbing component 1 by welding or with fixing members. For example, steel plates may be mounted to the rear surface of the non-collision wall 20 (a surface on a collision wall 10 side) at mounting points on the non-collision wall 20 as reinforcements and the fixing member that are passed through vias in the non-collision wall 20 and the steel plate may be fixed to the wall surfaces of the stays 2 disposed along the non-collision surface 1B.

Influences of the collision loads applied to the shock absorbing component 1 in the offset-collision vary based on a positional relation between the mounting points at which the stays 2 are mounted and load applied points to which the collision loads are applied. For example, if a collision load is applied to a point opposite the mounting point at which the stay 2 is mounted such as a collision load P2 indicated by a dash-line arrow in FIG. 1, the collision load is mainly received by the stay 2 on the right opposite the load applied point. Therefore, a stress is less likely to excessively concentrate in the shock absorbing component 1. If a collision load is applied to a point inner than the mounting points at which the stays 2 are mounted with respect to the width direction of the vehicle such as a collision load P3 indicated by a double-dashed-line arrow in FIG. 1, the load transmitted through the shock absorbing component 1 in the width direction of the vehicle because the shock absorbing component 1 is restrained at points beside the load applied point by the stays 2. The load is spread and received by the stays 2 on the right and the left. If a collision load is applied to a point outer than the mounting points at which the stays 2 are mounted with respect to the width direction of the vehicle such as a collision load P1 indicated by a solid-line arrow in FIG. 1, displacement of the free end 12 is allowed because the shock absorbing component 1 has a cantilever configuration at the load applied point; however, the inner portion of the shock absorbing component 1 with respect to the width direction of the vehicle (closer to the stay 2) is restrained by the stay 2. Therefore, a moment load with respect to the width direction of the vehicle increases and a stress concentrates on the mounting point at which the stay 2 is mounted on the left and therearound closer to the load applied point. Among the three cases described above, if the offset-collision in which the collision load P1 is applied occurs, deformation of the shock absorbing component 1 due to the concentration of the stress may be more likely to occur in a relatively early stage of the collision. In the following description, the offset-collision in which the collision load P1 is applied to the point outer than the mounting point at which the stay 2 is mounted with respect to the width direction of the vehicle may be referred to as “P1 collision.”

<<Evaluation Experiments>>

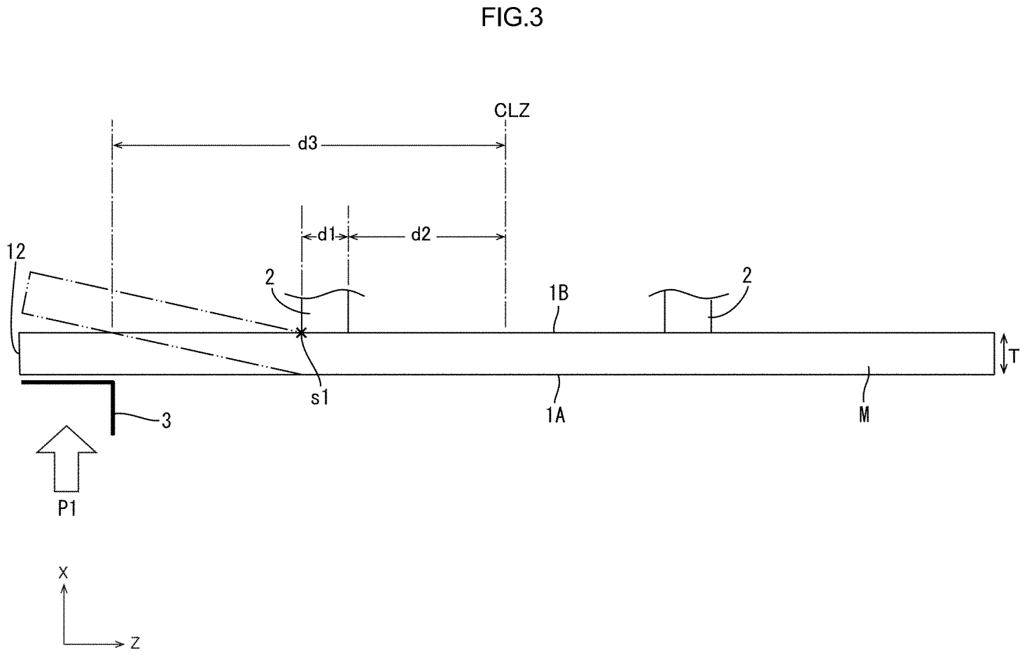

To evaluate influences of positions of the inner rib 50 and the recesses 11 and 21 on the collision performance (P1 collision performance) of the shock absorbing component 1 in the P1 collision, evaluation experiments 1 to 6 were conducted. FIG. 3 is a top view of a shock absorbing component model M used in the evaluation experiments. In the following description, shock absorbing component models according to examples and comparative examples may be referred to as shock absorbing component models M when common features of the shock absorbing component models are described. When the shock absorbing component models according to the examples and the comparative examples are distinctively described, they may be referred to as shock absorbing component model E1, shock absorbing component models C1, and as such.

The shock absorbing component models M were formed from 7000-series aluminum alloy hollow extrusions having a 0.2% proof strength of 425 MPa. The shock absorbing component models M included X-Y cross sections in a shape illustrated in FIG. 2 unless otherwise noted regarding the examples and the comparative examples. The wall widths of the collision wall 10 and the non-collision wall 20 of each shock absorbing component model M in the top-bottom direction in FIG. 2, that is, a length W of the non-collision surface 1B in the top-bottom direction and a distance T between the collision surface 1A and the non-collision surface 1B were set to 150 mm and 110 mm, respectively. The length of each shock absorbing component model M in the width direction of the vehicle was set to 2320 mm. The wall thickness of the collision wall 10 was set to 5.5 mm. The wall thickness of the non-collision wall 20 was set to 6.0 mm. The wall thickness of the inner rib 50 was set to 4.2 mm. The upper wall 30 and the lower wall 40 were formed such that the wall thickness of the upper wall 30 and the lower wall 40 gradually increased from 5.0 mm to 7.0 mm from the collision wall 10 side to the non-collision wall 20 side.

As illustrated in FIG. 3, each shock absorbing component model M included two stays 2 that included ends welded to sections of the non-collision surface 1B, respectively (reinforcement steel plates are not used). Each stay 2 had a width d1 that was 115 mm with respect to the width direction of the vehicle (the Z-axis direction). The stay 2 was positioned such that a distance d2 between an inner end of the stay 2 and the centerline CLZ of the shock absorbing component model M was 375.5 mm. The stay 2 was completely fixed and provided as a rigid body. An offset-collision barrier 3 was mounted to the shock absorbing component model M such that a distance d3 between an inner end of the offset-collision barrier 3 and the centerline CLZ of the shock absorbing component model M was 938 mm and a total area of a rear surface contacted the collision surface 1A. Each P1 collision experiment was conducted such that the offset-collision barrier 3 that was the rigid body was pressed from the rear side of the vehicle toward the front (in a direction indicated by the arrow in FIG. 3) until a stroke reached a predefined amount. For each P1 collision experiment, an FEM analysis was conducted using RADIOSS (registered trademark), which was versatile finite element analysis software. A load-stroke diagram up to the stroke of 100 mm was obtained and the P1 collision performance was evaluated.

<<Evaluation>>

The P1 collision performance was evaluated from two aspects: [A] an initial load that expressed a degree of rigidity in an initial stage of the collision; and [B] a load maintaining characteristic that expressed a degree of load-bearing capacity in a later stage of the collision. Specifically, the initial load [A] at a stroke of 40 mm was preferably equal to or greater than 104 kN, more preferably, equal to or greater than 115 kN in the load-stroke diagram obtained from the P1 collision experiment. The load maintaining characteristic [B] was preferably equal to or greater than 104 kN at a stroke of 80 mm, more preferably, equal to or greater than 110 kN. The shock absorbing component models M having [A] out of the above range may not be able to receive impact of the collisions and thus may be easily deformed. The shock absorbing component models M having [B] out of the above range may buckle in relatively early stages of the collisions. In either case, sufficient energy absorbing efficiency may not be achieved.

To maintain the benefits of using the aluminum alloy hollow extrusions resulting in weight reduction, areas of cross sections [C] of solid sections of the X-Y cross sections were evaluated. Specifically, the areas of the cross sections were preferably less than 3600 mm2, more preferably, less than 3550 mm2. The shock absorbing components M having [C] out of the above range may be increased in weight, that is, the benefits of using the aluminum alloy hollow extrusions for the vehicular components having the shock absorbing structure instead of steel may be undermined.

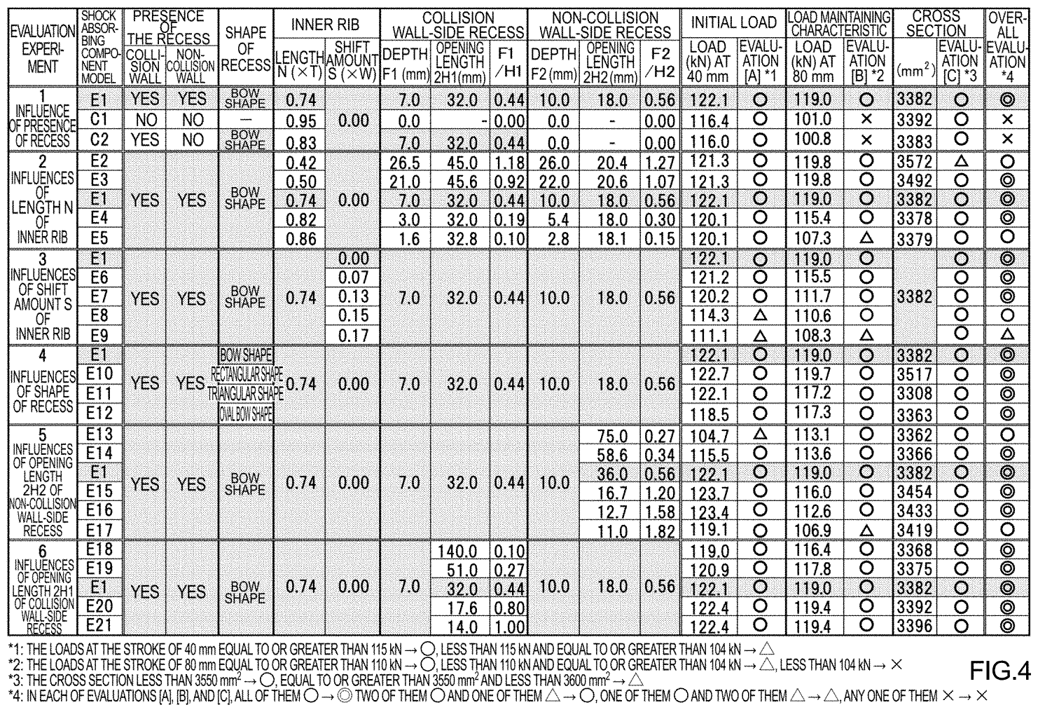

Evaluation experiments 1-6 will be descried in sequence. A table in FIG. 4 contains profiles of the shock absorbing component models M according to the examples and the comparative examples used for evaluations and results of the evaluations. Parameters according to the profiles of the shock absorbing component models M are the same as those of the shock absorbing component 1 illustrated in FIG. 2. Regarding the inner rib, a length N corresponds to the length of the inner rib 50 in a direction from the collision wall 10 to the non-collision wall 20 (the X-axis direction) expressed using the distance T between the collision surface 1A and the non-collision surface 1B (a distance between the middle of the wall thickness of the collision wall 10 and the middle of the wall thickness of the non-collision wall 20). A shift amount S is an amount of position shift of the inner rib 50 from the centerline CLY (the middle between the upper surface of the upper wall and the lower surface of the lower wall) with respect to the top-bottom direction of the shock absorbing component 1 (the Y-axis direction) expressed using the length W of the non-collision surface 1B with respect to the top-bottom direction. Regarding a collision wall-side recess, a depth F1 corresponds to a distance between the middle of the wall thickness of the collision wall 10 and the collision surface 1A at the bottom of the collision wall-side recess 11. An opening length 2H1 expresses a length of an opening in the collision surface 1A. Regarding a non-collision wall-side recess 21, a depth F2 corresponds to a distance between the middle of the wall thickness of the non-collision wall 20 and the non-collision surface 1B at the bottom of the non-collision wall-side recess 21. An opening length 2H2 expresses a length of an opening in the non-collision surface 1B.

Regarding the above described [A], the results of the experiment of each shock absorbing component model M are evaluated in the table in FIG. 4 with symbols “◯” and “Δ” (loads at the stroke of 40 mm are all equal to or greater than 104.0 kN). The loads at the stroke of 40 mm equal to or greater than 115 kN are marked with symbol “◯”. The loads at the stroke of 40 mm equal to or greater than 104.0 kN and less than 115 kN are marked with symbol “Δ”. Regarding the above described [B], the loads at the stroke of 80 mm equal to or greater than 110 kN are marked with symbol “◯”. The loads at the stroke of 80 mm equal to or greater than 104.0 kN and less than 110 kN are marked with symbol “Δ”. The loads at the stroke of 80 mm less than 104.0 kN are marked with symbol “x”. Regarding the above described [C], the areas of the cross sections of the shock absorbing component models M less than 3550 mm2 are marked with symbol “◯”. The cross sections of the shock absorbing component models M equal to greater than 3550 mm2 and less than 3600 mm2 are marked with symbol “Δ” (the areas of all cross sections are less than 3600 mm2). In view of the evaluations results of all categories of the performance, overall evaluations were made. If all of the above described [A] to [C] are marked with symbol “◯”, the overall evaluation is marked with symbol “⊚”. If two of them are marked with symbol “◯” and one of them is marked with symbol “Δ”, the overall evaluation is marked with symbol “◯”. If one of them is marked with symbol “◯” and two of them are marked with symbol “Δ”, the overall evaluation is marked with symbol “Δ”. If at least one of them is marked with symbol “X”, the overall evaluation is marked with symbol “X”. The shock absorbing component models M with the overall evaluations marked with symbol “Δ” or above are considered to deliver sufficient P1 collision performance. The shock absorbing component models M with the overall evaluations marked with symbol “◯” or above are considered to deliver favorable P1 collision performance. The shock absorbing component models M with the overall evaluations marked with symbol “⊚” are considered to deliver exceptionally superior P1 collision performance.

### Evaluation Experiment 1: Influences of Presence of Recess

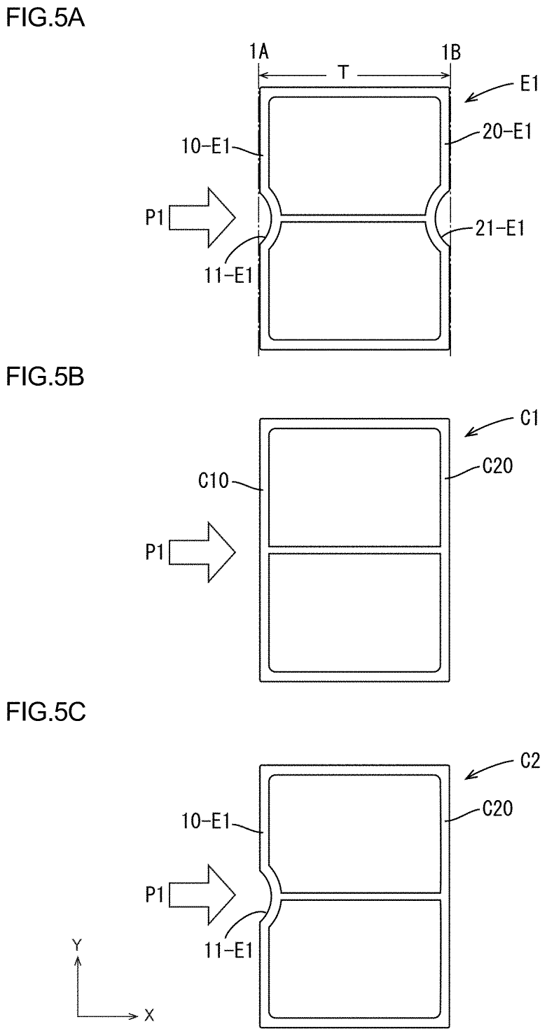

Influences of presence of the recesses 11 and 21 on the P1 collision performance were evaluated using shock absorbing component models E1, C1, and C2 according to example 1 and comparative examples 1 and 2. FIGS. 5A to 5C illustrate cross sections of the shock absorbing component models E1, C1, and C2. As illustrated in FIG. 5, the shock absorbing component model E1 according to example 1 includes a collision wall 10-E1 and a non-collision wall 20-E1 with recesses 11-E1 and 21-E1, respectively. Namely, the shock absorbing component model E1 has a double recessed cross section (the shock absorbing component model E1 is defined as a standard of the shock absorbing component models M in evaluation experiments 1 to 6. Therefore, the results of the evaluation experiment of the shock absorbing component model E1 are referred in evaluation experiments 2 to 6). As illustrated in FIG. 5B, the shock absorbing component model C1 according to comparative example 1 did not include recesses in a collision wall C10 and a non-collision wall C20. Namely, the shock absorbing component model C1 had a B-shaped cross section. As in the table in FIG. 4, a collision wall-side recess 11-E1 had a depth F1 of 7 mm and an opening length 2H1 of 32.0 mm. A non-collision wall-side recess 21-E1 had a depth F2 of 10.0 mm and an opening length 2H2 of 36.0 mm. A length N of an inner rib of the shock absorbing component model E1 was 0.74T. A length N of an inner rib of the shock absorbing component model C1 was 0.95T. A length N of an inner rib of the shock absorbing component model C2 was 0.83T.

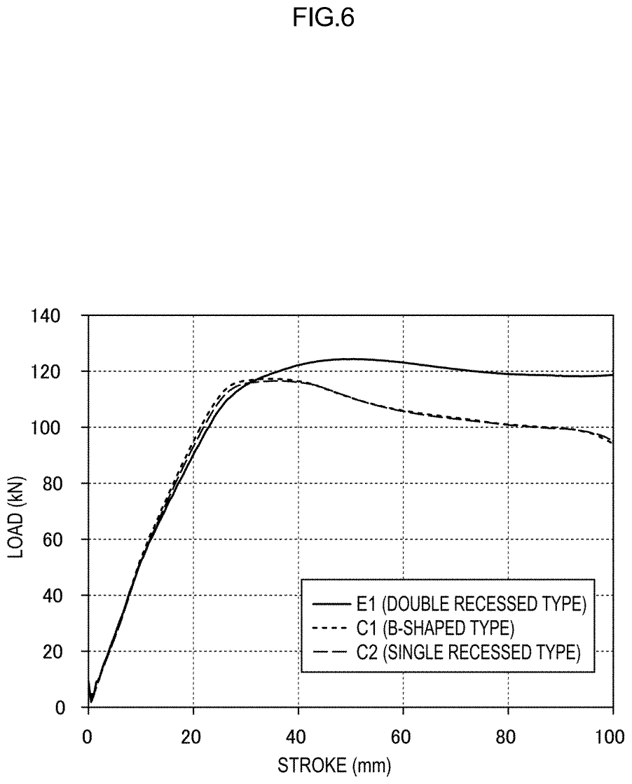

FIG. 6 is a load-stroke diagram obtained through an offset collision analysis of the shock absorbing component model E1 (a double recessed type) according to example 1, the shock absorbing component model C1 (a B-shaped type) according to comparative example 1, and the shock absorbing component model C2 (a single recessed type) according to comparative example 2. As illustrated in FIG. 6, in the shock absorbing component models C1 and C2 according to the comparative examples, increased in load in early stages of strokes were slightly faster than an increase in load in the shock absorbing component model E1 according to the example. Distinct decreases in load were observed in the early stage of the strokes. Stresses may rapidly concentrate on the inner ribs that extend closer to the stays 2 (a pivot point s1 in FIG. 3) in the early stage of the P1 collision experiment and thus the buckling of the inner ribs may have occurred. In the shock absorbing component models C1 and C2 having the B-shaped cross section or the single recessed cross section, buckling of the inner ribs occurred in the relatively early stage of the P1 collision and thus a sufficient load maintaining characteristic was hardly achieved. Namely, difficulty in increase in energy absorbing efficiency was shown in the P1 collision.

In results of the analysis of the shock absorbing component model E1 according to example 1, the load increased after the start of the collision experiment. Namely, the maximum load greater than the maximum load obtained in the shock absorbing component models C1 and C2 was achieved. An ability to maintain the larger load until a late stage of the stroke was confirmed. In the shock absorbing component model E1, the inner rib did not reach the non-collision surface on which the stay 2 was mounted. The collision load transmitted to the inner rib via the collision wall may be spread along the bottom of the non-collision wall-side recess before reaching the non-collision surface and thus the concentration of the stress on the inner rib may be reduced. Therefore, timing of the buckling may be delayed. In the shock absorbing component model E1 according to example 1, it was confirmed that a large initial load and a satisfactory load maintaining characteristic were achieved and thus the energy absorbing efficiency in the P1 collision was increased.

### Evaluation Experiment 2: Influences of Length N of Inner Rib

Influence of the length N of the inner rib in the front-rear direction (the X-axis direction) on the P1 collision performance were evaluated using shock absorbing component models E1 to E5 according to example 1 and examples 2 to 5. The length N of the inner rib is 0.74T in the shock absorbing component model E1 according to example 1. In the shock absorbing component models E1 to E5, as illustrated in FIG. 4, the lengths N of the inner ribs were altered by adjusting the depths F1 and F2 and the opening lengths 2H1 and 2H2 of the collision wall-side recesses and the non-collision wall-side recesses. The length N of the inner ribs was 0.42T in the shock absorbing component model E2 according to example 2. The length N of the inner ribs was 0.50T in the shock absorbing component model E3 according to example 3. The length N of the inner ribs was 0.82T in the shock absorbing component model E4 according to example 4. The length N of the inner ribs was 0.86T in the shock absorbing component model E5 according to example 5.

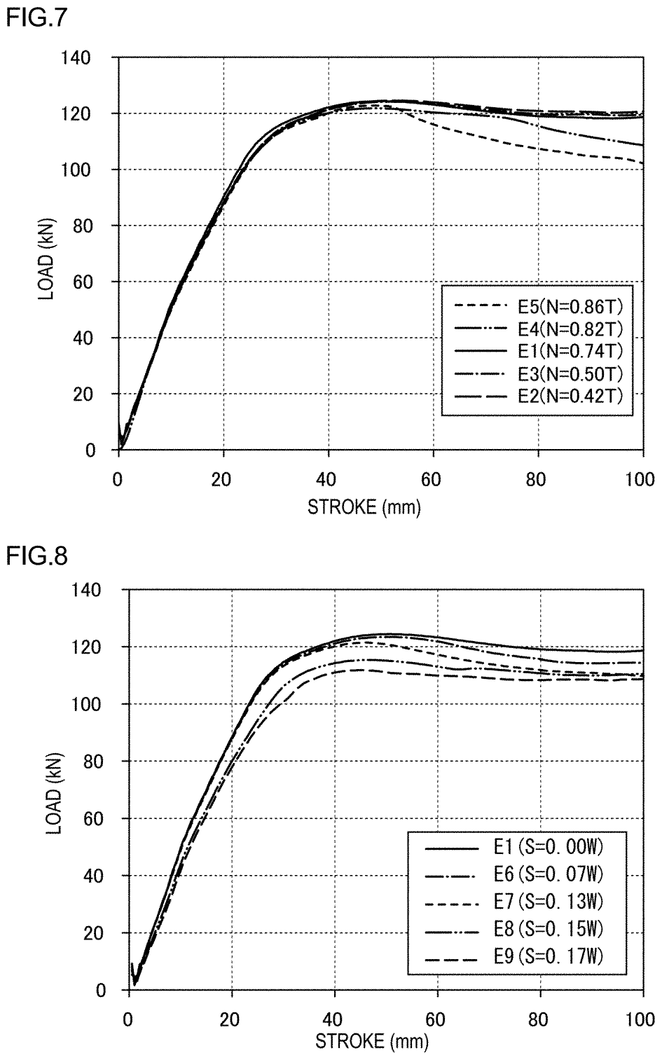

FIG. 7 is a load-stroke diagram obtained through an offset collision analysis of the shock absorbing component models E1 to E5 according to examples 1 to 5. As illustrated in FIG. 7, in the shock absorbing component models E1 to E5, decreases in load were not observed in the early stage of the strokes after the maximum loads equal to or greater than 120 kN were achieved. In the shock absorbing component models E1 to E5 including the collision wall-side recesses and the non-collision wall-side recesses, the inner ribs did not buckle in the early stages of the P1 collision and it was confirmed that certain levels of P1 collision performance could be delivered. In the shock absorbing component model E5 that included the inner rib having the length N of 0.86T, the maximum load about equal to the maximum loads obtained in the shock absorbing component models E1 to E4 was achieved after the load was increased in the early stage of the stroke. However, a decrease in load was observed in a middle stage of the stroke. A buckling strength of the inner rib of the shock absorbing component model E5 was small because the inner rib was relatively long. Therefore, the buckling of the inner rib may occur in the middle stage of the stroke. In the shock absorbing component models E1 to E4 that included the inner ribs having the lengths N equal to or less than 0.83T, distinct decreases in collision load were not observed until the late stages of the strokes. Not only the concentration of stresses on the inner ribs may be decreased by forming the non-collision wall-side recesses but also the buckling strengths may be increased by reducing the lengths N of the inner ribs. Therefore, the load maintaining characteristics may be enhanced. If the length N of the inner rib is equal to or less than 0.5T such as in the shock absorbing component model E2, the area of the cross section increases. The lightweight benefits obtained by using the aluminum alloy hollow extrusions may be undermined. In the shock absorbing component models E1 and E3 to E5, the areas of the cross sections were maintained in the preferable range. It was confirmed that the shock absorbing component models E1, E3, and E4 that included the inner ribs having the lengths N of 0.5T or greater and less than 0.83T could achieve especially large initial loads and superior load maintaining characteristics while maintaining the lightweight properties and thus the energy absorbing efficiency could be effectively increased.

### Evaluation Experiment 3: Influences of Position of Inner Rib (Shift Amount S)

Influences of positions of the inner ribs on the P1 collision performance were evaluated using shock absorbing component models E1 and E6 to E9 according to example 1 and examples 6 to 9. In the shock absorbing component model E1 according to example 1, the inner rib is arranged such that the centerline of the wall thickness was on the centerline CLY of the shock absorbing component model E1 with respect to the Y-axis direction (a shift amount S of the inner rib position was OW). In the shock absorbing component models E6 to E9, as illustrated with the double-dashed-line in FIG. 2, the inner ribs were moved upward. The collision wall-side recesses and the non-collision wall-side recesses were moved along with the inner ribs. The shift amount S from the inner rib position in the shock absorbing component model E6 according to example 6 was 0.07 W. The shift amount S from the inner rib position in the shock absorbing component model E7 according to example 7 was 0.13 W. The shift amount S from the inner rib position in the shock absorbing component model E8 according to example 8 was 0.15 W. The shift amount S from the inner rib position in the shock absorbing component model E9 according to example 9 was 0.17 W. In the shock absorbing component models E6 to E9, as illustrated in FIG. 4, the dimensions and the shapes of the recesses were not altered, that is, the parameters except for the shift amount S were the same as those of the shock absorbing component model E1.

FIG. 8 is a load-stroke diagram obtained through an offset collision analysis of the shock absorbing component models E1 and E6 to E9 according to examples 1 and 6 to 9. As illustrated in FIG. 8, in the shock absorbing component models E1 and E6 to E9, decreases in load were not observed in the early stage of the strokes after the maximum loads were achieved in the early stage of the strokes. In the shock absorbing component models E8 and E9 with the shift amount S of 0.15 W or greater, the increases in load in the early stage of the strokes were relatively slow and the maximum loads were relatively low. One of the wall widths (the wall widths w1-1 and w1-2 in FIG. 2) of the shock absorbing component models E8 and E9 was increased and thus the rigidity of the portions of the collision wall may decrease. In the shock absorbing component models E1, E6, and E7 with the shift amounts of 0.14 W or less, the relatively large loads were maintained after the loads rapidly increased in the early stages of the strokes and the maximum loads of 120 kN or greater were achieved without distinct decreases in load until the late stage of the strokes. The shock absorbing component models E1, E6, and E7 with the shift amounts of 0.14 W or less could achieve especially large initial loads and favorable load maintaining characteristics while maintaining the lightweight properties and thus the energy absorbing efficiency could be effectively increased.

### Evaluation Experiment 4: Influences of Shape of Recess

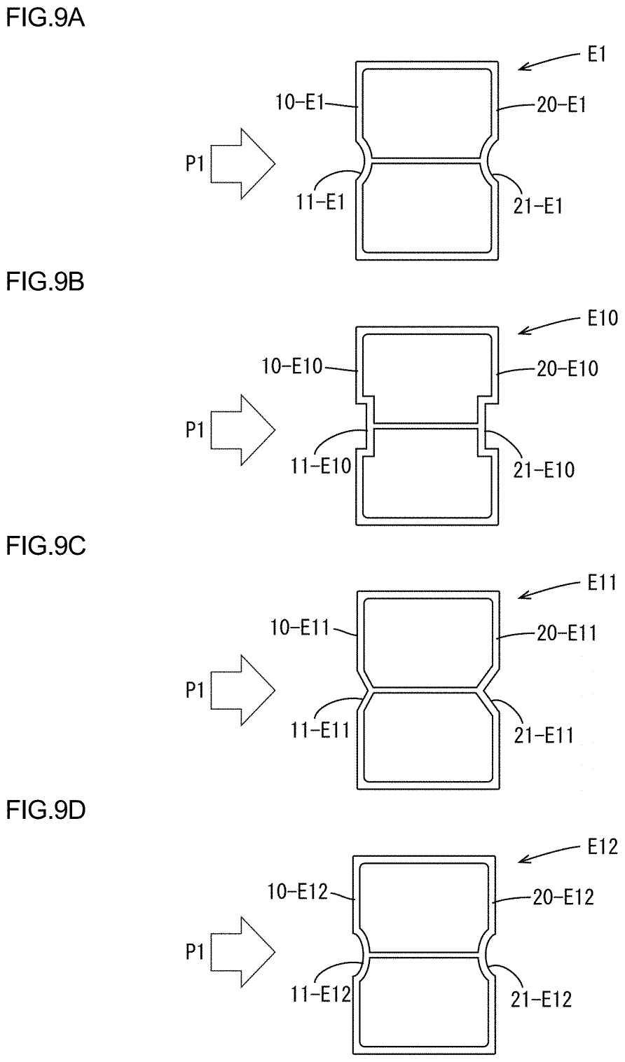

Influences of the shapes of the collision wall-side recesses and the non-collision wall-side recesses on the P1 collision performance were evaluated using the shock absorbing component models E1 and E10 to E12 according to example 1 and examples 10 to 12. FIGS. 9A to 9D illustrate the cross sections of the shock absorbing component models E1 and E10 to E12. In the shock absorbing component model E1 according to example 1, as illustrated in FIG. 9A, the collision wall-side recess 11-E1 and the non-collision wall-side recess 21-E1 had the bow-shaped cross sections. In the shock absorbing component model E10 according to example 10, as illustrated in FIG. 9B, shapes of the collision wall 10-E10 and the non-collision wall 20-E10 were altered such that the cross sections of the recesses 11-E10 and 21-E10 were rectangular. In the shock absorbing component model E11 according to example 11, as illustrated in FIG. 9C, shapes of the collision wall 10-E11 and the non-collision wall 20-E11 were altered such that the cross sections of the recesses 11-E11 and 21-E11 were triangular. In the shock absorbing component model E12 according to example 12, as illustrated in FIG. 9D, shapes of the collision wall 10-E12 and the non-collision wall 20-E12 were altered such that the cross sections of the recesses 11-E12 and 21-E12 were an oval-bow shape (a figure defined by a section of an oval and a string connecting an end of the section of the oval to the other end).

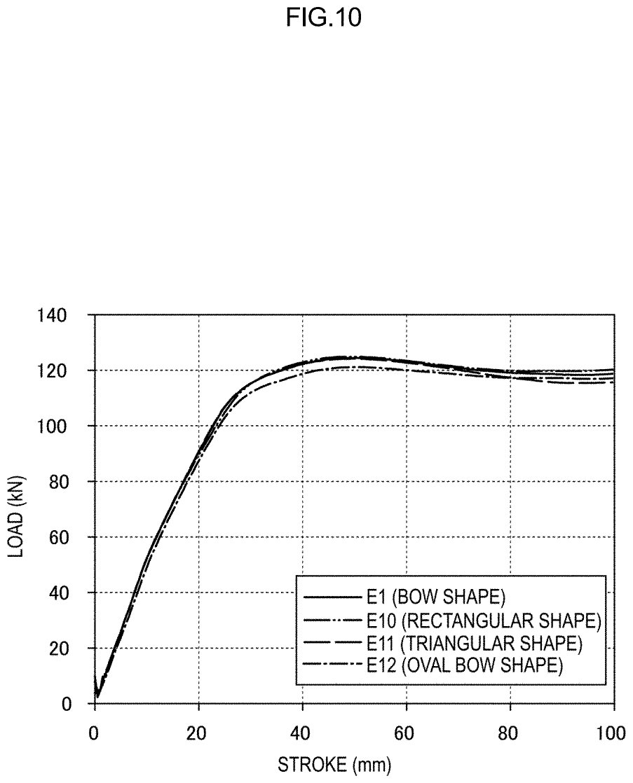

FIG. 10 is a load-stroke diagram obtained through an offset analysis of the shock absorbing component models E1 and E10 to E12 according to examples 1 and 10 to 12. As illustrated in FIG. 10, in the shock absorbing component models E1 and E10 to E12, the loads were equally increased in the early stages of the strokes. After the maximum loads were achieved, distinct decreases in load were not observed until the late stages of the strokes. In the recesses 21-E1 and 21-E10 to 21-E12, the collision loads transmitted from the collision walls to the inner ribs were spread along the bottoms of the non-collision wall-side recesses before reaching the non-collision surfaces that was a mounting surface on which the stays 2 were mounted. Therefore, the buckling of the inner ribs may be reduced. The shock absorbing component models E1 and E10 to E12 that included the recesses having the bow shape, the rectangular shape, and the oval bow shape could achieve especially large initial loads and favorable load maintaining characteristics and thus the energy absorbing efficiency could be effectively increased.

### Evaluation Experiment 5: Influences of Opening Length 2H2 of Non-Collision Wall-Side Recess

Influences of the opening lengths 2H2 of the non-collision wall-side recesses on the P1 collision performance were evaluated using the shock absorbing component models E1 and E13 to E11 according to example 1 and examples 13 to 17. In the shock absorbing component model E1 according to example 1, the depth F2 of the non-collision wall-side recess was 10.0 mm and the opening length 2H2 was 36.0 mm so that a ratio of the depth F2 to a half of the opening length 2H2 (i.e., F2/H2) was 0.56. In shock absorbing component models E13 to E11 according to examples 13 to 17, the depths F2 were fixed to 10.0 mm but the opening lengths 2H2 were altered as in the table in FIG. 4. The ratio F2/H2 in the shock absorbing component model E13 according to example 13 was 0.27. The ratio F2/H2 in the shock absorbing component model E14 according to example 14 was 0.34. The ratio F2/H2 in the shock absorbing component model Ely according to example 15 was 1.20. The ratio F2/H2 in the shock absorbing component model E16 according to example 16 was 1.58. The ratio F2/H2 in the shock absorbing component model E11 according to example 17 was 1.82. In the shock absorbing component models E1 and E13 to 17, the dimensions and the shapes of the collision wall-side recesses were all the same as those of the shock absorbing component model E1.

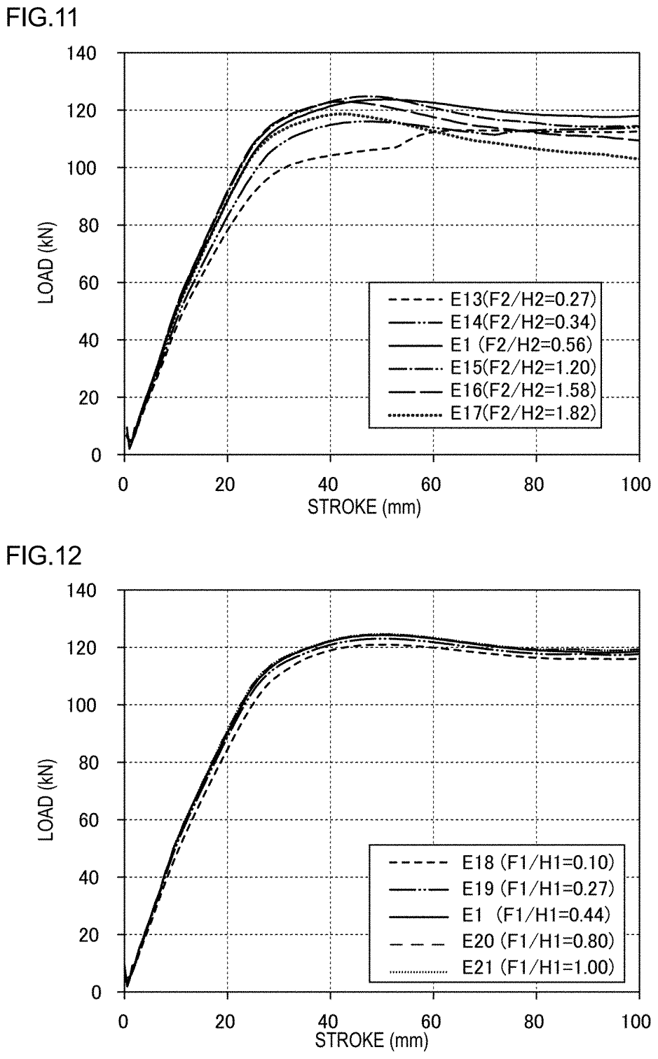

FIG. 11 is a load-stroke diagram obtained through an offset collision analysis of the shock absorbing component models E1 and E13 to E11 according to examples 1 and 13 to 17. As illustrated in FIG. 11, in the shock absorbing component models E1 and E13 to E17, decreases in load were not observed in the early stages of the strokes. In the shock absorbing component model E13 having the F2/H2 ratio of 0.27, the increase in load was relatively slow in the early stage of the stroke and it was confirmed that the rigidity was low. Although the decreases in load in the middle stage and the late stage of the stroke were not observed, the load were generally low. In the shock absorbing component model E11 having the F2/H2 ratio of 1.60 or greater, the load increased similarly to the shock absorbing component models E1 and E14 to E16 in the early stage of the stroke. However, the decrease in load was observed in the middle stage of the stroke. In the shock absorbing component model E17, the buckling strength of the inner rib was relatively small in comparison to the shock absorbing component models E1 and E14 to E16 and thus the inner rib may buckle in the middle stage of the stroke. In the shock absorbing component models E1 and E14 to E16 having the F2/H2 ratios of 0.30 or greater and less than 1.60, distinct decreases in load were not observed after the loads rapidly increased in the early stage of the strokes and the maximum loads of 120 kN or greater were achieved until the late stage of the strokes. Namely, the relatively large loads were maintained. The shock absorbing component models E1 and E14 to E16 that include the non-collision wall-side recesses having the F2/H2 ratios of 0.3 or greater and less than 1.60 could achieve especially large initial loads and favorable load maintaining characteristics and thus the energy absorbing efficiency could be effectively increased.

### Evaluation Experiment 6: Influences of Opening Length 2H1 of Collision Wall-Side Recess

Influences of the shapes of the collision wall-side recesses on the P1 collision performance were evaluated using the shock absorbing component models E1 and E18 to E21 according to example 1 and examples 18 to 21. In the shock absorbing component model E1 according to example 1, the depth F1 of the collision wall-side recess was 7.0 mm and the opening length 2H1 was 32.0 mm so that a ratio of the depth F1 to a half of the opening length 2H1 (i.e., F1/H1) was 0.44. In shock absorbing component models E18 to E21 according to examples 18 to 21, the depths F1 were fixed to 7.0 mm but the opening lengths 2H1 were altered as in the table in FIG. 4. The ratio F1/H1 in the shock absorbing component model E18 according to example 18 was 0.10. The ratio F1/H1 in the shock absorbing component model E19 according to example 19 was 0.27. The ratio F1/H1 in the shock absorbing component model E20 according to example 20 was 0.80. The ratio F1/H1 in the shock absorbing component model E21 according to example 21 was 1.00. The shock absorbing component models E1 and E18 to E21 included the non-collision wall-side recesses having the dimensions and the shapes that were all the same as those of the shock absorbing component model E1.

FIG. 12 is a load-stroke diagram obtained through an offset collision analysis of the shock absorbing component models E1 and E18 to E21 according to examples 1 and 18 to 21. As illustrated in FIG. 12, in the shock absorbing component models E1 and E18 to E21, any differences were not observed in load performance. The loads rapidly increased in the early stage of the strokes and the maximum loads of 120 kN or greater were achieved. Distinct decreases in load were not observed until the late stage of the strokes. The inner ribs may not buckle until the late stage of the strokes. The shock absorbing component models E1 and E18 to E21 that included the non-collision surface-side recesses having the shapes in a predefined range and collision wall-side recesses having the F1/H1 ratios in a range from 0.10 to 1.00 including 1.00 could achieve large initial loads and favorable load maintaining characteristics and thus the energy absorbing efficiency could be effectively increased. With the collision wall-side recesses in the shapes having the F1/H1 ratios in a range from 0.10 to 1.00 including 1.00, the buckling strengths could be increased by adjusting the lengths N of the inner ribs along with the non-collision wall-side recesses.

As described above, the shock absorbing component 1 according to this embodiment has the following configuration.

(1) The shock absorbing component 1 (the vehicular component having the shock absorbing structure) according to this embodiment is to be mounted to the vehicle for absorbing an impact in a collision. The shock absorbing component 1 is formed from the aluminum alloy hollow extrusion having the elongated shape. The shock absorbing component 1 is disposed in the vertical direction. The shock absorbing component 1 includes the collision wall 10, the non-collision wall 20, the upper wall 30, the lower wall 40, and the inner rib 50. The collision wall 10 includes the first plate surface that is defined as the collision surface 1A. The non-collision wall 20 is parallel to the collision wall 10 on the opposite side from the collision surface 1A. The non-collision wall 20 includes the plate surface on the opposite side from the collision wall 10 and defined as the non-collision surface 1B. The upper wall 30 and the lower wall 40 connect the collision wall 10 to the non-collision wall 20. The inner rib 50 is between the upper wall 30 and the lower wall 40. The inner rib 50 connects the collision wall 10 to the non-collision wall 20. The shock absorbing component 1 is mounted to the vehicle with the stays (the mounting members) on the non-collision surface 1B. The collision wall 10 and the non-collision wall 20 include the collision wall-side recess 11 and the non-collision wall-side recess 21, respectively. The collision wall-side recess 11 is in the joint portion joined to the inner rib 50. The collision wall-side recess 11 is formed by recessing the section of the collision wall 10 toward the inner rib 50 in the longitudinal direction of the shock absorbing component 1. The non-collision wall-side recess 21 is in the joint portion joined to the inner rib 50. The non-collision wall-side recess 21 is formed by recessing the section of the non-collision wall 20 toward the inner rib 50 in the longitudinal direction of the shock absorbing component 1.

In the shock absorbing component 1 having the B shaped cross section and in which the weight is reduced by using the aluminum alloy hollow extrusion and the large initial load is achieved with the inner rib 50, not only the collision wall 10 but also the non-collision wall 20 includes the non-collision wall-side recess 21. According the configuration described above, the buckling of the inner rib 50 in the collision can be delayed. Specifically, the length N of the inner rib 50 in a direction in which the collision wall 10 and the non-collision wall 20 are connected is further reduced by forming the non-collision wall-side recess 21. This increases the buckling strength of the inner rib 50. Because the non-collision wall-side recess 21 is provided, the edge of the inner rib 50 on the non-collision wall 20 side does not reach the non-collision surface 1B that is the mounting surface on which the stays 2 are mounted. The load transmitted to the inner rib 50 in the collision is spread along the bottom of the non-collision wall-side recess 21 before reaching the non-collision surface 1B. Therefore, local concentration of the stresses on the portions of the inner rib 50 adjacent to the stays 2 may be reduced. According to the configuration, the buckling of the inner rib 50 is delayed and thus the reduction in load-bearing capacity is restricted in the early stage of the collision. The shock absorbing component 1 can absorb energy with a favorable degree of efficiency in the P1 collision in which deformation of the shock absorbing component 1 due to the concentration of the stress tends to occur in the early stage of the offset collision. The stress concentration reducing effect of the non-collision wall-side recess 21, which is one of two effects described above cannot be achieved by the collision wall-side recess 11. With the non-collision wall-side recess 21 included in the shock absorbing component 1, the energy absorbing efficiency in the P1 collision in which local concentration of the stress tends to occur can be effectively increased.

In this embodiment, the upper wall 30 and the lower wall 40 are reduced in thickness from the non-collision wall 20 toward the collision wall 10. According to the configuration, the weight can be reduced without reduction in initial load or load maintaining characteristic in comparison to a configuration in which the thicknesses of the upper wall 30 and the lower wall 40 are not reduced from the thicknesses on the non-collision wall 20 side. In this embodiment, both the upper wall 30 and the lower wall 40 are reduced in thickness; however, any one of the upper wall 30 and the lower wall 40 may be reduced in thickness. Alternatively, the inner rib may be reduced in thickness in addition to the reduction in thickness of the upper wall 30 and the lower wall 40.

The shock absorbing component 1 according to this embodiment may have the following configuration.

(2) In (1), the non-collision wall-side recess 21 of the non-collision wall 20 extends at least from the mounting points at which the stays 2 are mounted to the free ends at the ends of the shock absorbing component 1 in the longitudinal direction.

In the P1 collision, the stresses concentrate especially on the portions of the inner rib 50 adjacent to the mounting points at which the stays 2 are mounted. Therefore, the buckling of the inner rib 50 may easily occur in the early stage of the collision. In the configuration described above, the non-collision wall-side recess 21 is formed in the portion of the inner rib 50 that may easily buckle to extend from the mounting points at which the stays 2 are mounted to the free ends 12 of the shock absorbing component 1. Therefore, the buckling of the inner rib 50 is effectively delayed in the offset collision and thus the load maintaining characteristic of the shock absorbing component 1 can be enhanced.

It is preferable that the shock absorbing component 1 according to this embodiment has the following configuration.

(3) In (1) or (2), when the distance between the collision surface 1A and the non-collision surface 1B is defined as T, the length N of the inner rib 50 in the direction in which the collision wall 10 and the non-collision wall 20 are connected is in the range from 0.5 to 0.83 including the 0.83.

According to the configuration, load maintaining characteristic enhancing effect can be sufficiently achieved by forming the non-collision wall-side recess 21 while maintaining the lightweight effect achieved by using the aluminum alloy hollow extrusion and the initial load increasing effect achieved by disposing the inner rib 50 at the predefined position. Namely, in the shock absorbing component 1 including the hollow extrusion, the initial load is increased by disposing the inner rib 50 at the predefined position. A buckling strength of a column such as the inner rib 50 depends on a slenderness ratio (a ratio of the length N of the inner rib 50 in a direction in which the load is applied to an area of the cross section perpendicular to the direction). If an area of the cross section (especially the wall thickness of the inner rib 50) is constant, the longer the length N is, the easier the buckling occurs. By reducing the length N of the inner rib 50, the load maintaining characteristic of the shock absorbing component 1 can be enhanced. In the shock absorbing component 1, if the ratio of the length N of the inner rib 50 to the distance T is less than the above range, the area of the cross section increases and thus the weight increases. Further, the initial load increasing effect achieved with the inner rib 50 may decrease. If the ratio is greater than the above range, the load maintaining characteristic enhancing effect achieved by forming the recesses 11 and 21 decreases.

It is preferable that the shock absorbing component 1 according to this embodiment has the following configuration.

(4) In any one of (1) to (3), when the length of the non-collision surface 1B in the top-bottom direction is defined as W, the inner rib 50 is disposed at the position such that the shift amount S from the middle between the upper surface of the upper wall and the lower surface of the lower wall is equal to or less than 0.14 W.

According to the configuration, not only the initial load increasing effect produced though the mounting of the inner rib 50 at the predefined position but also the load maintaining characteristic enhancing effect produced through the forming of the recesses 11 and 21 are sufficiently achieved. The moment load applied to the inner rib 50 increases as the shift of the position of the inner rib 50 from the middle between the upper wall 30 and the lower wall 40 increases. Therefore, the buckling-resistant strength tends to decrease. If the shift amount S of the position of the inner rib 50 is greater than the range described above, the buckling of the inner rib 50 may easily occur and the energy absorption efficiency of the shock absorbing component 1 may decrease.

It is preferable that the shock absorbing component 1 according to this embodiment has the following configuration.

(5) In any one of (1) to (4), the recess 21 in the non-collision wall 20 has the cross section in the bow shape, the oval bow shape, the rectangular shape, or the triangular shape.

According to the configuration, the load maintaining characteristic enhancing effect can be sufficiently achieved. With the non-collision wall-side recess 21 in the shape described above, the force from the inner rib 50 may be spread and transmitted to the non-collision surface 1B on which the stays 2 were mounted and thus the load maintaining characteristic of the shock absorbing component 1 may be enhanced.

It is preferable that the shock absorbing component 1 according to this embodiment has the following configuration.

(6) In any one of (1) to (5), when the opening width of the recess 21 in the non-collision wall 20 was defined as 2H2 and the depth of the recess 21 from the non-collision surface 1B was defined as F2, the ratio F2/H2 was in the range from 0.3 to 1.6 including 1.6.

According to the configuration, the collision load transmitted to the inner rib 50 was properly spread along the bottom of the non-collision wall-side recess 21 and transmitted to the non-collision surface 1B on which the stays 2 were mounted. Therefore, the load maintaining characteristic enhancing effect may be sufficiently achieved. If the ratio F2/H2 is less than the range described above (the depth F2 was smaller relative to the opening length 2H2), the load may be easily transmitted to the non-collision surface 1B. If the ratio F2/H2 is greater than the range described above (the opening length 2H2 was smaller relative to the depth F2), the load transmitted to the non-collision surface 1B may not be sufficiently spread and thus the concentration of the stress on a specific portion of the inner rib 50 may not be reduced. Therefore, deformation or buckling may easily occur.

### OTHER EMBODIMENTS

Various modification, revision, or improvement may be added to the technology disclosed herein within intent of the present invention based on knowledge of a person skilled in the art. The following embodiments may be included in the technical scope of the present technology.

(1) In the above embodiment, the vehicular component having the shock absorbing structure including a single inner rib between the upper wall and the lower wall is provided as an example. However, multiple ribs may be provided between the upper wall and the lower wall. In such a configuration, all joint portions of the non-collision wall joined to the inner ribs and may include non-collision wall-side recesses or some of the joint portions may include the non-collision wall-side recesses.

(2) In the above embodiment, the linear-type vehicular component having the shock absorbing structure is provided as an example. However, the technology described herein may be applied to a curved-type vehicular component having a shock absorbing component.

(3) In the above embodiment, the shock absorbing component used for the RUP mounted to the back surface of the vehicle is provided as an example. However, the technology described herein may be applied to vehicular components having shock absorbing structures mounted to front surfaces of vehicles and side surfaces of the vehicles.

### EXPLANATION OF SYMBOLS

1: shock absorbing component (an example of a vehicular component having a shock absorbing structure), 1A: collision surface, 1B: non-collision surface, 2: stay (an example of a mounting member), 3: offset collision barrier, 10, 10-E1, 10-E10-10-E12, C10: collision wall, 11, 11-E, 11-E10-11-E12: collision wall-side recess, 12: free end, 20, 20-E1, 20E10-20-E12, C20: non-collision wall, 21, 21-E1, 21-E10-21-E12: non-collision wall-side recess, 30: upper wall, 40: lower wall, 50: inner rib, CLY: centerline (of the shock absorbing component in the top-bottom direction), CLZ: centerline (of the shock absorbing component in the width direction of the vehicle), T: distance (between the collision surface and the non-collision surface), W: length (of the inner rib), S: shift amount (of the inner rib), F1: depth (of the collision wall-side recess), F2: depth (of the non-collision wall-side recess), 2H1: opening length (of the collision wall-side recess), 2H2: opening length (of the non-collision wall-side recess), s1: pivot point, w1-1, w1-2: wall width, M, E1-E21, C1, C2: shock absorbing component model

1. A vehicular component having a shock absorbing structure formed from an aluminum alloy hollow extrusion in an elongated shape and mounted to a vehicle to absorb an impact in a collision, the vehicular component having the shock absorbing structure comprising:
a collision wall being disposed in a vertical direction and including a plate surface defined as a collision surface;
a non-collision wall being disposed parallel to the collision wall on an opposite side from the collision surface and including a plate surface disposed on an opposite side from the collision wall and defined as a non-collision surface;
an upper wall and a lower wall connecting the collision wall to the non-collision wall; and
an inner rib being disposed between the upper wall and the lower wall to connect the collision wall to the non-collision wall, wherein
the vehicular component having the shock absorbing structure is mounted to the vehicle with a mounting member on the non-collision surface,
the collision wall includes a joint portion joined to the inner rib,
the non-collision wall includes a joint portion joined to the inner rib,
the joint portion of the collision wall includes a recess formed by recessing the collision wall toward the inner rib in a longitudinal direction of the vehicular component having the shock absorbing structure, and
the joint portion of the non-collision wall includes a recess formed by recessing the non-collision wall toward the inner rib in the longitudinal direction of the vehicular component having the shock absorbing structure.

2. The vehicular component having the shock absorbing structure according to claim 1, wherein the recess in the non-collision wall extends at least from a mounting point at which the mounting member is mounted to a free end at an end of the vehicular component having the shock absorbing structure in the longitudinal direction.

3. The vehicular component having the shock absorbing structure according to claim 1, wherein
when a distance between the collision surface and the non-collision surface is defined as T, a length of the inner rib in a direction in which the collision wall and the non-collision wall are connected is in a range from 0.5T to 0.83T including 0.83T.

4. The vehicular component having the shock absorbing structure according to claim 1, wherein
when a length of the non-collision surface in a top-bottom direction is defined as W, a shift amount of the inner rib from a middle of the vehicular component having the shock absorbing structure in the top-bottom direction is equal to or less than 0.14 W.

5. The vehicular component having the shock absorbing structure according to claim 1, wherein
the recess in the non-collision wall has a cross section perpendicular to the longitudinal direction in a bow shape, an oval bow shape, a rectangular shape, or a triangular shape.

6. The vehicular component having the shock absorbing structure according to claim 1, wherein
when an opening width of the recess in the non-collision surface of the non-collision wall is defined as 2H and a depth from the non-collision surface is defined as F, a ratio F/H is in a range from 0.3 to 1.6 including 1.6.
